(19) United States
(12) Patent Application Publication
(10) Pub. No.: US 2025/0373617 A1
(43) Pub. Date: Dec. 4, 2025

(54) Cloud Security Management

(71) Applicant: NetApp, Inc., San Jose, CA (US)

(72) Inventors: Alex Xeong-Hoon Ough, Austin, TX (US); Yun Shen, Bristol (GB); Azzedine Benameur, Fairfax, VA (US)

(73) Assignee: NetApp, Inc., San Jose, CA (US)

(21) Appl. No.: 18/923,748

(22) Filed: Oct. 23, 2024

Related U.S. Application Data
(60) Provisional application No. 63/654,826, filed on May 31, 2024.

(51) Int. Cl. H04L 9/40; H04L 41/16

(52) U.S. Cl. CPC H04L 63/105; H04L 41/16; H04L 63/20

(57) ABSTRACT

Systems and methods are disclosed for implementing a system to generate a knowledge graph of trust relationships between roles in a cloud environment, and to identify misconfigurations that may lead to privilege escalation. In certain embodiments, a method may comprise implementing a graph-based role permission inspection system for identity and access management (IAM) roles in a cloud environment, including generating a graph representation of trust relationships between roles, where a first role having a first set of privileges can endorse a second role having a second set of privileges. The method may further include determining whether the second set of privileges includes a permission not available in the first set of privileges, and generating an indicator that the first role violates a policy when the second set of privileges includes the permission not available in the first set of privileges.

### CROSS-REFERENCE TO RELATED APPLICATION

The present application claims priority to pending U.S. Provisional Patent Application No. 63/654,826, filed May 31, 2024, entitled “CLOUD SECURITY MANAGEMENT”, the contents of which are hereby incorporated by reference in their entirety.

### FIELD

Various embodiments of the present disclosure generally relate to cloud security and machine-learning (ML) technology. In particular, some embodiments relate to use of a knowledge graph of all trust relationships enabled by a given Identity and Access Management (IAM) role to facilitate various use cases including static analysis, proactive security, and compromise analysis.

### BACKGROUND

Identity and Access Management (IAM) in traditional environments is complex. It gets even more complex in the cloud (e.g., Amazon Web Services (AWS), Google Cloud Platform (GCP), and Microsoft Azure), making it harder to determine who or what has access to cloud resources (e.g., object storage containers or buckets, virtual machine instances, and the like), and what they can do (e.g., their level of access or permissions).

In the cloud, an IAM user has permanent long-term credentials which may be used to directly interact with services (e.g., object storage services, computing services, and the like) in the cloud (e.g., Amazon Web Services (AWS), Google Cloud Platform (GCP), and Microsoft Azure) services. However, when considering transitive properties such as cross-account role endorsement, for example enabled by AssumeRole in the context of AWS and similar features in other cloud environments, the complexity referenced above is further exacerbated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In certain embodiments, a method may comprise implementing a graph-based role permission inspection system for identity and access management (IAM) roles in a cloud environment, including generating a graph representation of trust relationships between roles, where a first role having a first set of privileges can endorse a second role having a second set of privileges. The method may further include determining whether the second set of privileges includes a permission not available in the first set of privileges, and generating an indicator that the first role violates a policy when the second set of privileges includes the permission not available in the first set of privileges.

In certain embodiments, a system may comprise an identity and access management (IAM) policy analysis system configured to implement a graph-based role permission inspection system for IAM roles in a cloud environment, the IAM policy and analysis system configured to generate a graph representation of trust relationships between roles, where a first role having a first set of privileges can endorse a second role having a second set of privileges. The system may further determine whether the second set of privileges includes a permission not available in the first set of privileges, and generate an indicator that the first role violates a policy when the second set of privileges includes the permission not available in the first set of privileges.

In certain embodiments, a memory device may store instructions that, when executed, cause a processor to perform a method comprising implementing a graph-based role permission inspection system for identity and access management (IAM) roles in a cloud environment, including generating a graph representation of trust relationships between roles, where a first role having a first set of privileges can endorse a second role having a second set of privileges. The instructions may cause the processor to perform the method further comprising determining whether the second set of privileges includes a permission not available in the first set of privileges, and generating an indicator that the first role violates a policy when the second set of privileges includes the permission not available in the first set of privileges.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 depicts a diagram of a system configured to implement cloud security management, in accordance with certain embodiments of the present disclosure.

FIG. 2 depicts a diagram of a system configured to implement cloud security management, in accordance with certain embodiments of the present disclosure.

FIG. 3 depicts a diagram of a system configured to implement cloud security management, in accordance with certain embodiments of the present disclosure.

FIG. 4 depicts a diagram of a system configured to implement cloud security management, in accordance with certain embodiments of the present disclosure.

FIG. 5 depicts a diagram of a system configured to implement cloud security management, in accordance with certain embodiments of the present disclosure.

FIG. 6 depicts a flowchart of an example method for implementing cloud security management, in accordance with certain embodiments of the present disclosure.

FIG. 7 depicts an example algorithm for implementing cloud security management, in accordance with certain embodiments of the present disclosure.

FIG. 8 depicts an example algorithm for implementing cloud security management, in accordance with certain embodiments of the present disclosure.

FIG. 9 depicts a diagram of a system configured to implement cloud security management, in accordance with certain embodiments of the present disclosure.

FIG. 10 depicts a flowchart of an example method for implementing cloud security management, in accordance with certain embodiments of the present disclosure.

FIG. 11 depicts an example algorithm for implementing cloud security management, in accordance with certain embodiments of the present disclosure.

FIG. 12 depicts a diagram of a system configured to implement cloud security management, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a physical device, such as a computer readable storage medium or memory device, including instructions that, when executed, cause a processor to perform the methods.

As used herein a “cloud,” “cloud system,” “cloud platform,” “cloud computing environment,” and/or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a hyperscaler (which may also be referred to herein as a cloud service provider or simply a cloud provider) (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), Infrastructure-as-a-Service (IaaS), and/or Function-as-a-Service (FaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds). As used herein, “cloud infrastructure” or simply “infrastructure” generally refers to cloud services, infrastructure, platforms, or software that are hosted by a cloud service provider and made available to users through the Internet.

Systems and methods are described for cloud security management. Transitive properties such as cross-account role endorsement, for example, enabled by AssumeRole in the context of AWS, enables users to endorse different roles to access cloud resources that they might not normally have access to. Such cross-account role endorsement may be achieved via an Application Programming Interface (API) call, for example, that returns a set of temporary security credentials that consist of an access key identifier (ID), a secret access key, and a security token. While this feature enables great visibility in segmenting roles and permissions within the IAM policies, it does not guarantee that the least privileges principle is enforced consistently. It is also extremely difficult to understand the scope of permissions a given user can get access to by endorsing multiple roles, thus enabling privilege escalation in some instances. Privilege escalation may be a cyber attack technique that allows a malicious actor to gain unauthorized access to a system or network and increase their level of access to resources. If a given role can use AssumeRole to endorse or assign role credentials having greater access permissions or privileges than the original assigning role, for example due to system misconfigurations, then a malicious actor may be able to gain greater privileges and cause further system harm.

While cross-account role endorsement (e.g., via AssumeRole) represents an essential and important service in the context of various cloud environments, usage of such functionality can obfuscate the true scope of permissions a given user may have, and may result in security risks. For example, without graphically representing existing relationships, it may be very hard to see the overall trust relationships among roles, especially when a series of role endorsements are chained in a same or different accounts. Furthermore, a minor misconfiguration can cause serious security risks.

In order to, among other things, prevent privilege escalation in IAM policies and understand the scope of permissions enabled by each AssumeRole, a knowledge graph-based approach is proposed herein to facilitate analysis of trust relationships enabled by various roles. According to one embodiment, a static approach is provided in which a knowledge graph of all the trust relationships enabled by a given role may be created that maps these trust relationships when multiple roles are chained, thereby making it easier for security analysts to spot misconfigurations, poor policy definitions, and privilege escalations paths.

This static approach may be extended to take into consideration runtime event data available from a cloud environment, for example from logs or services (e.g., a cloud activity trace, such as AWS CloudTrail, Azure ActivityLog, GCP Cloud Audit Logs), by combining the runtime event data with the knowledge graph. In various embodiments, using such runtime event data in combination with the knowledge graph allows overly permissive roles and policies to be identified proactively.

According to an example embodiment, an IAM policy analysis system is provided that may make use of a graph neural network (GNN) to perform static analysis, recommend proactive security measures, or perform compromise analysis based on a graph representing available access information across multiple user accounts. A GNN may enable identification of problematic or compromised nodes in a first system based on identified troublesome or concerning nodes in a second system, based on similarity calculations.

While various examples may be described with reference to a particular cloud service provider (e.g., Amazon), a particular cloud environment or platform (e.g., AWS), and particular features and functionality (e.g., AssumeRole and CloudTrail) offered by the particular cloud provider, it is to be appreciated the methodologies described herein are equally applicable to other cloud providers (e.g., Google and Microsoft) and their respective cloud environments and similar functionality and features provided by these other cloud providers.

In the following description, numerous specific details are set forth in order to provide a thorough understanding of embodiments of the present disclosure. It will be apparent to one skilled in the art, however, that embodiments of the present disclosure may be practiced without some of these specific details. In some instances, certain structures and devices are shown in block diagram form.

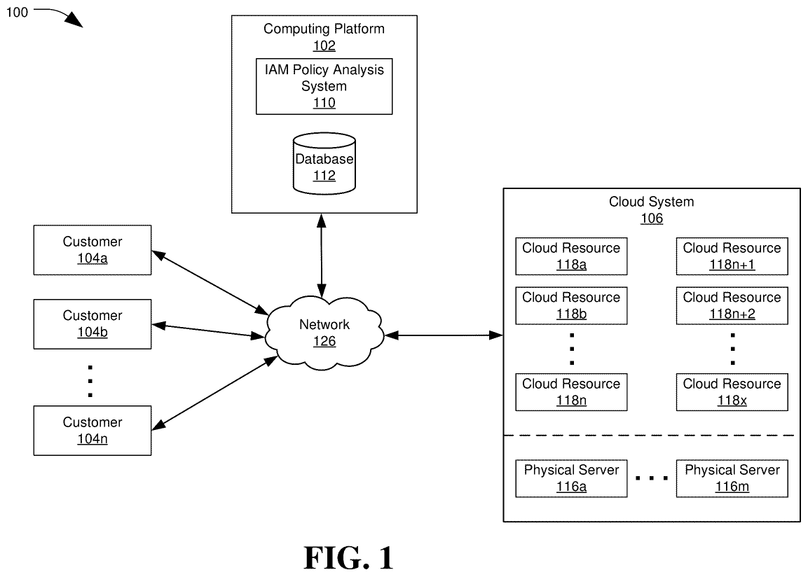

FIG. 1 depicts a diagram of a system 100 configured to implement cloud security management, in accordance with certain embodiments of the present disclosure. The system 100 may include, among other things, a computing platform 102, one or more cloud customers (e.g., customers 104a-n), and a cloud system 106. These aspects of the system 100 may communicate with each other via a network 126. The network 126 may be, for example, the Internet, a local area network, a wide area network, or a wireless network (to name a few examples). The network 126 may include a variety of transmission media including cables, optical fibers, wireless routers, firewalls, switches, gateways, or other devices to facilitate communications between one or more of the aspects of the system 100.

Cloud system 106 may be a provider of cloud infrastructure for one or more of the cloud customers 104. Each cloud customer 104 may include a business, enterprise, or other organization encompassing a plurality of user accounts and roles, and that may have its own policies, permissions, resources, and other configurations for its cloud environment. Cloud system 106 may represent a cloud platform of a cloud provider through which the cloud provider offers a variety of cloud computing solutions, such as IaaS (infrastructure as a service), Saas (software as a service), or PaaS (platform as a service), other solutions, or any combination thereof. For example, cloud system 106 may be a public cloud provider, non-limiting examples of which include AWS, Microsoft Azure, and GCP. The cloud system 106 may represent a multi-tenant cloud provider that may host a variety of virtualization tools that cloud customers 104 may request to host or otherwise run one or more applications (e.g., via the network 126). Alternatively, the cloud system 106 may represent a private cloud provider, such as an enterprise cloud for a given organization.

Cloud system 106, generally, may provide infrastructure including any set of cloud resources 118 for providing various services to the cloud customers 104. Non-limiting examples of cloud resources may include object storage containers or buckets (e.g., Simple Storage Service (S3) buckets), virtual machine instances (e.g., AWS elastic compute cloud (EC2) instances), and the like. Examples of these cloud resources are illustrated in FIG. 1 as cloud resources 118a-x of cloud system 106. The cloud resources 118 may be implemented via one or more physical server devices, such as physical servers 116a-m.

The usage model for the cloud system 106 may vary from customer-to-customer. For example, customer 104a (or another of customers 104b-n, but referring to 104a for simplicity herein) may make use of various cloud-native services (e.g., object storage services, compute services, and the like) via respective user accounts associated therewith. Various cloud customer 104 user accounts and roles may have varying levels of access and permissions for cloud resources 118a-118x.

The environment 100 may further include computing platform 102. The computing platform 102 may be part of a cloud analytics, recommendation, or security platform utilized by cloud customers 104. In other examples, the computing platform 102 may be part of a larger service offering (e.g., NetApp's Spot cloud automation solution, available from NetApp, Inc. of San Jose, CA) that goes beyond cloud analytics, security, and recommendations and also facilitates automation or optimization of cloud customers' cloud infrastructure in one or more cloud platforms (e.g., cloud system 106, non-limiting examples of which include AWS, Azure, and GCP). In some examples, computing platform 102 may be part of or incorporated into cloud system 106, or part of or incorporated into the systems of cloud customers 104a-n. Depending on the particular relationship between cloud customers 104 and the computing platform 102, the computing platform 102 may observe various interactions between the cloud customers 104 and the cloud system 106, facilitate such interactions, or perform monitoring of various aspects of the cloud system 106 on behalf of cloud customers 104, for example, to help cloud customers 104 make optimal or secure use of cloud services and cloud resources 118, or provide input or recommendations to cloud customers 104 to facilitate or prioritize cloud security management.

In the context of the present example, the computing platform 102 is shown including an IAM policy analysis system 110 and a database 112. These may be executed by one or more processors of one or more computer systems or modules, for example. In one embodiment, as a result of its relationship with cloud customers, the cloud platform 102 may receive (e.g., directly from cloud customers or via the cloud system 106) and collect over time current or historical information relating to IAM roles and policies utilized by various user accounts, or associated with various cloud services or cloud resources 118. For example, computing platform 102 may collect information regarding AssumeRole events, including how they were started, by whom, as well as when and where. In some examples, the IAM policy analysis system 110 may collect the information in the form of CloudTrail runtime event data, via an application programming interface (API) call to cloud system 106, or via other means.

Based on collected information regarding available access information across multiple accounts of a given cloud customer 104, which may be stored in the database 112 (e.g., a graph database), a knowledge graph of all trust relationships enabled by a given Identity and Access Management (IAM) role may be created or presented to an administrative user of the cloud customer 104 to facilitate various use cases including static analysis, proactive security, and compromise analysis. A graph database may be defined as a platform for creating and manipulating data in the form of graphs. Graphs may contain nodes, edges, and properties, all of which may be used to represent and store data in a way that relational databases are not equipped to do. In an example embodiment, nodes of a graph may represent elements of a system, such as accounts, roles, resources, or other objects, and the edges may define how the nodes are related to each other. Graphs that have been identified as including problematic configurations, such as privilege escalation paths, may be utilized by a GNN for comparisons against roles in other systems (e.g., for other customers 104), or to identify other problematic roles within a same system, to proactively identify similar configuration problems.

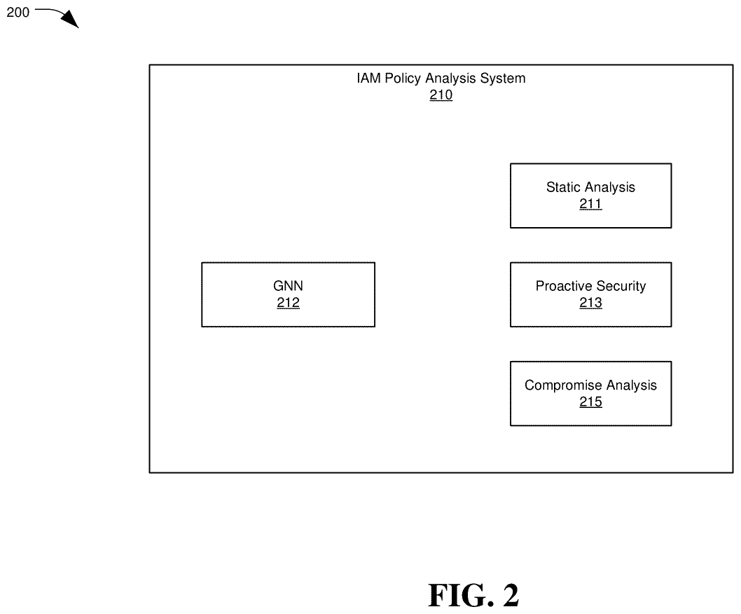

While in the context of the present example, the database 112 is shown as being part of the computing platform 102, it is to be appreciated in other examples the database 112 may be in communication with the computing platform 102 (e.g., part of a separate computing platform, etc.). An example IAM policy analysis system 110 is described in regard to FIG. 2.

FIG. 2 depicts a diagram of a system 200 configured to implement cloud security management, in accordance with certain embodiments of the present disclosure. In particular, FIG. 2 may depict a block diagram illustrating various functional units of an IAM policy analysis system 210, which may correspond to IAM policy analysis system 110 of FIG. 1. In this example, a graph neural network (GNN) 212 may be used to facilitate various use cases, including, for example, identification and analysis or nodes and paths in a graph, or role similarity inspection via node clustering. IAM policy analysis system may also perform static analysis via a static analysis module 211, proactive security analysis via a proactive security module 213, or compromise analysis via a compromise analysis module 215, which components may rely upon or operate in conjunction with GNN 212, in some examples.

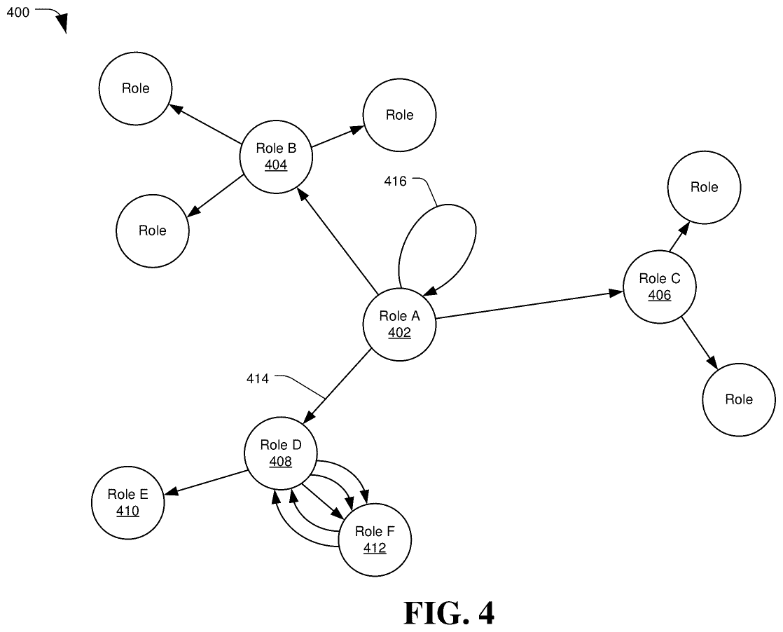

According to one embodiment, static analysis module 212 may present overall traversal of all trust relationships across all or some subset of accounts of a cloud customer (e.g., one of cloud customers 104a-n) using graph visualization. The static analysis module 212 may also detect misconfiguration and unintended trust relationships that can cause security risks. For example, various self-assuming scenarios and multiple-assuming scenarios, as illustrated by FIG. 4, may be proactively identified and brought to the attention of an administrative user or security personnel of the cloud customer. Additionally or alternatively, the static analysis module 212 may group the trust relationships based on their patterns and may pinpoint any abnormal trust relationships, which can show the level of importance. This may allow security personnel to prioritize their activities based on the level of importance.

Proactive security module 213 may provide configuration analysis based on the history of AssumeRole activities using activity logging data, such as CloudTrail events. In one embodiment, proactive security module 213 may filter out trust relationships that are never used or have been unused for a threshold amount of time based on the activity events. In this manner, the configuration may be simplified so as to prevent possible security risks.

Compromise analysis module 215 may extract failed AssumeRole events from the CloudTrail events, and may provide information graphically or textually regarding how they were started and may additionally provide such information regarding by whom, when, or where such failed AssumeRole events were attempted.

GNN 212 may identify and analyze nodes in a graph to extract meaningful insights, and to perform graph-based role similarity inspection. In an example embodiment, a GNN model 212 may compute embeddings for nodes in a graph, which may be vector representations that capture the structural and feature information of the nodes. Based on an identified target node, the GNN 212 may perform similarity calculations to identify other nodes in the same or other graphs that are most similar to the target node. This analysis can help identify other nodes that may have similar permission vulnerabilities or exploits, allowing for proactive protective measures.

In accordance with various embodiments, the IAM policy analysis system 210 may proactively perform, automate, or otherwise facilitate various cloud security management tasks including, but not limited to, review and evaluation of the current trust relationships to verify if the overall traversals have any unintended paths, diagnosis of the configurations based on the activities to remove unnecessary relationships, analysis of all different patterns and fixing of any abnormal or inefficient trust relationships, and making sure the relationships with high importance are without any misconfiguration. The described procedures may be used to identify and prevent potential avenues of privilege escalation.

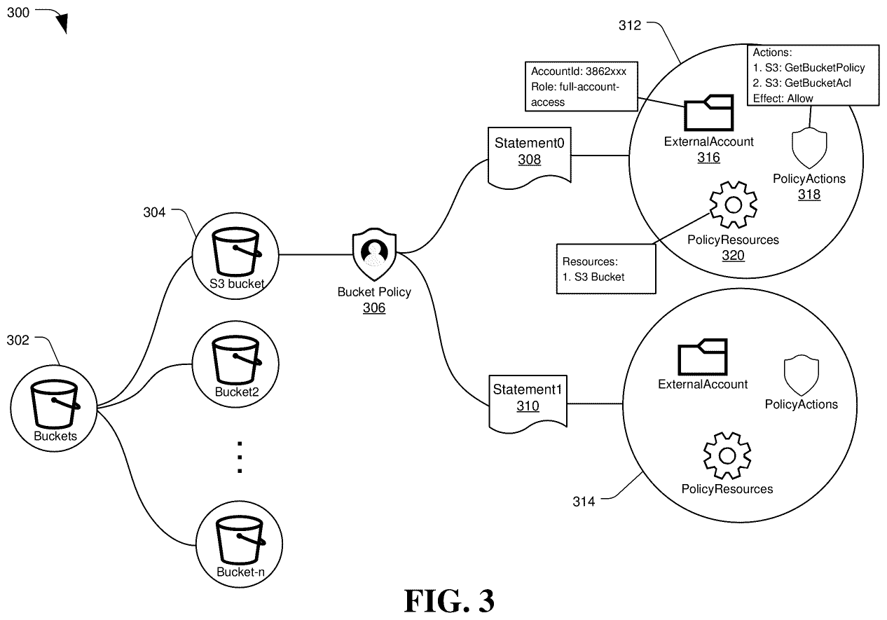

The various modules and the like of IAM policy analysis system 210 and the processing described herein may be implemented in the form of executable instructions stored on a machine readable medium and executed by one or more processing resources (e.g., one or more microcontrollers, one or more microprocessors, one or more CPU cores, one or more ASICs, one or more FPGAs, or the like, and/or a combination of one or more of the foregoing), or in the form of other types of electronic circuitry. For example, the processing may be performed by one or more virtual or physical computer systems of various forms, such as the computer system described below with reference to FIG. 12. An example system employing IAM is described in regard to FIG. 3.

FIG. 3 depicts a diagram of a system 300 configured to implement cloud security management, in accordance with certain embodiments of the present disclosure. In particular, FIG. 3 may depict an example of a system 300 managing access to a cloud resource by external accounts. System 300 may include cloud resources in the form of a plurality of buckets 302 including a Simple Storage Service (S3) bucket 304, a bucket policy 306, policy documents 308 and 310, and a plurality of accounts 312 and 314. The accounts 312-314 may correspond to cloud customer 104 accounts of FIG. 1, while buckets 302-304 may correspond to cloud resources 118 of cloud system 106 of FIG. 1.

In the context of the present example, each bucket 302 may have corresponding policies regarding access by external accounts having the correct permissions. In particular, the S3 bucket 304 may have a bucket policy 306 that controls what external account permissions are required to access the S3 bucket 304, and what sort of actions the various permissions allow. If an account (which may have a corresponding role) does not have the correct permissions as required by the bucket policy 306, the account may not be granted access to S3 bucket 304. The policies may be enforced by a cloud system 106 or other entity.

Each account 312-314 may have a corresponding policy document 308-310, respectively, that describes the account 316, its allowed policy actions 318, and the corresponding cloud resources 320 on which the policy actions may be used by the user account. In the depicted example, account 312 may have external account information 316 providing an external account identifier (ID) number and role; for example, account 3862xxx having role “full-account-access”. Account 312's available policy resources 320 may be for S3 bucket 304, and the S3-related policy actions 318 may include ‘GetBucketPolicy’ and ‘GetBucketAcl’ (wherein ACL may be an access control list). The account 312 information, may be provided via ‘Statement0’ policy document 308 for evaluation based on the bucket policy 306 for S3 bucket 304. Based on the policy document 308, the account 312 may be given access permission to S3 bucket 304 only to the extent of performing ‘GetBucketPolicy’ and ‘GetBucketAcl’ actions. An example knowledge graph is described in regard to FIG. 4.

FIG. 4 depicts a diagram of a system 400 configured to implement cloud security management, in accordance with certain embodiments of the present disclosure. In particular, FIG. 4 is an example of a graph showing available access information across multiple accounts or roles (represented as nodes of the graph). The graph of system 400 may include multiple accounts or roles, including Role A 402, Role B 404, Role C 406, Role D 408, Role E 410, and Role F 412. A given role may have the ability, using a feature such as AssumeRole, to endorse another account or role with certain privileges to access certain cloud resources. It is generally desirable that a target role cannot endorse a role with access privileges that the target role does not have, to avoid privilege escalation. A target role may be considered to assume or inherit access privileges from any role or account it endorses, or from any role or account endorsed by a role that the target role endorsed (which may be referred to as chained roles or endorsements). In the depicted example graph, endorsements or inheritances between roles may be depicted as edges (e.g., edges 414 and 416) between the nodes. Based on static analysis performed using the holistic view presented by a knowledge graph as shown in system 400, an administrative user of a cloud customer (e.g., one of cloud customers 104a-n) can visually inspect and understand how many accounts are assumed and how they are assumed without having to log in to each account and check all roles individually. A user may be able to utilize a user interface (UI) of a graph visualization to identify privileges or other attributes associated with each node, and quickly identify issues.

There may be various cross-account role endorsement scenarios (e.g., enabled by AssumeRole) that an administrative user or security personnel of a cloud customer (e.g., one of cloud customers 104a-n) may wish to be informed of, for example, including self-assuming scenarios (e.g., as illustrated by Role A 402 endorsing or inheriting from itself via edge 416) and multiple-assuming scenarios to the same account (e.g., as illustrated between Role D 408 and Role F 412). An administrative user or security personnel of the cloud customer may wish to investigate such scenarios to determine whether they were intentionally performed and, if not, how they can be fixed or simplified.

Privilege escalation issues may also be identified via the knowledge graph of system 400. In the depicted example, Role A 402 may endorse Role B 404, Role C 406, and Role D 408, as shown by directed edges 414. Accordingly, any privileges available to Roles B-D 404-408 can be assumed to be available to Role A 402 as well. The endorsements 414 may depict actual endorsements between roles or accounts, or potential endorsements which Role A 402 has the capacity or privileges to create.

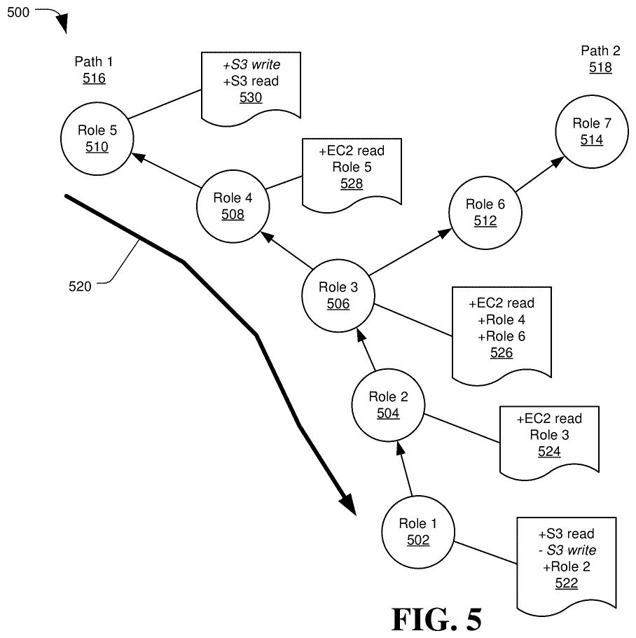

Each of Roles B-D 404-408 may also have further roles or accounts that they have or may endorse, such as Role E 410 and Role F 412 endorsed by Role D 408. While Role A 402 may not have direct endorsements to Role E-F 410-412, due to the concept of chaining of roles or endorsements, any role or account that can be endorsed by Roles B-D 404-408 may be considered to be able to be endorsed by (and inherited to) Role A 402. Therefore, permissions or privileges available to Roles E-F 410-412 are considered available to Role D 408, which in turn are available to Role A 402. Even if none of Roles B-D 404-408 violate privilege escalation principles for Role A 402, privilege escalation may still be violated if either of Role E-F 410-412 have permissions that are not supposed to be available to Role A 402. An example of policy-based role inspection is described in regard to FIG. 5.

FIG. 5 depicts a diagram of a system 500 configured to implement cloud security management, in accordance with certain embodiments of the present disclosure. In particular, FIG. 5 may depict an example AssumeRole graph showing all AssumeRole paths for a target role. By identifying all AssumeRole paths, an administrator or security personnel can ensure that the paths do not contain any roles having permissions that the target role is not supposed to have. This may involve a comprehensive review of permissions assigned to each node in the paths. System 500 may include a target role of Role 1 502, as well as Role 2 504, Role 3 506, Role 4 508, Role 5 510, Role 6 512, and Role 7 514, contained within a Path 1 516 and Path 2 518. Each node or role may have a corresponding set of permissions, depicted as permission sets 522-530. The endorsement of roles from one node to another may be depicted based on the directed edges between the nodes, and the path of potential privilege or permissions inheritance back to Role 1 512 along Path 1 516 is depicted by arrow 520.

Policy-based permission or role inspection may include performing path analysis to identify the permissions of all roles and corresponding permissions for all paths from a target role. Path analysis may include first identifying all endorsement paths from a target node. In the example scenario of FIG. 5, Role 1 502 may be the target role, which may endorse Role 2 504, which in turn may endorse Role 3 506. Role 3 506 may endorse Role 4 508 as well as Role 6 512, creating a branch between Path 1 516 and Path 2 518. Along Path 1 516, Role 4 508 may endorse Role 5 510, while on Path 2 518, Role 6 512 may endorse Role 7 514.

Path analysis may also include inspecting nodes in each path to determine their assigned permissions. These permissions may then be compared against the permissions or policies of the target node, to ensure that no node in the paths would allow the target node to inherit permissions that it should not have. Any nodes that violate the policies of the target node may be flagged for evaluation or correction. The target Role 1 502 may have a permission set 522 that includes S3 read permissions, but should not include S3 write permissions. Notably, Role 1's permission set 522 also includes all permissions held by Role 2 504, since Role 1 502 endorsed Role 2 504 and can assume or inherit permissions from any roles it can endorse.

Role 2 504 may include a permission set 524 that includes EC2 read permission, and all permissions of Role 3 506. Role 2's permission set 524 is compliant on its face with Role 1's policies, as it does not include S3 write permissions, but Role 3 506 should be evaluated.

Role 3 506 may have a permission set 526 including EC2 read, and any permissions of Role 4 508 and Role 6 512. As with Role 2 504, Role 3 506 is compliant as it does not include S3 write permission, but the permissions of Role 4 508 and Role 6 512 should be evaluated.

Role 4 508 may have a permission set 528 including EC2 read, and any permissions of Role 5 510. As above, Role 4 508 is compliant as it does not include S3 write permission, but the permissions of Role 5 510 should be evaluated.

Role 5 510 has a permission set 530 that includes S3 read, and also S3 write, which violates the policies of Role 1 502. Accordingly, Role 1 502 may violate its policy since it can inherit S3 write permission from Role 5 510 along line 520. Path 1 may therefore have privilege escalation misconfigurations that may be addressed. Roles 6-7 512-514 of Path 2 518 may or may not also have policy violations for target Role 1 502, and may also be evaluated as part of the policy-based role inspection process.

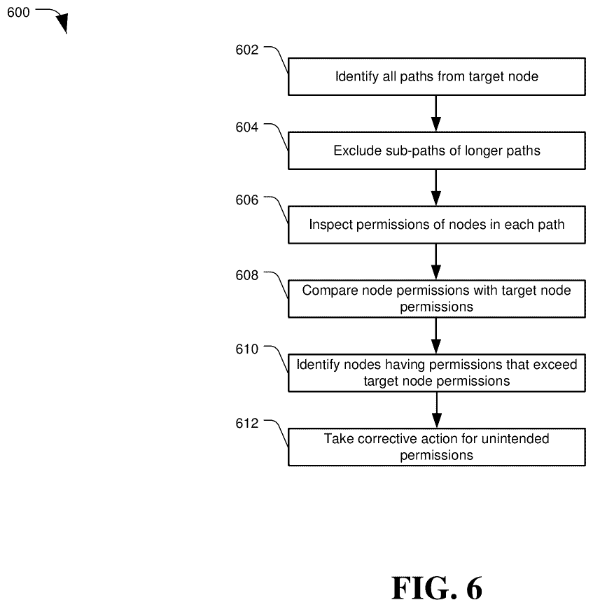

By following this structured approach, an IAM policy analysis system can systematically identify and report any nodes that contain permissions which are not supposed to be granted to the target role 502, ensuring compliance and security within the system 500. An example process for policy-based permission or role inspection and path analysis is detailed in FIG. 6.

FIG. 6 depicts a flowchart 600 of an example method for implementing cloud security management, in accordance with certain embodiments of the present disclosure. In particular, the method of FIG. 6 may be a process for identifying role endorsement or inheritance paths from a target role or account, and determining whether any permissions along those paths violate a policy of the target role. The method may be implemented by components described in regard to FIG. 1, such as computing platform 102, IAM policy analysis system 110, and database 112 of FIG. 1. Other components, such as cloud customers 104a-n, network 126, and cloud system 106, or some combination thereof, may also be involved in the method of FIG. 6.

The method may include identifying all paths from the target node, at 602. This may include enumerating all possible paths from a target node to a destination node within the graph. If an example target node is 1, and the paths between node 1 and 3 include paths 1-2-3, 1-4-3, and 1-5-6-3, each path may be listed separately.

However, shorter paths that are subsets of longer paths may be excluded, at 604. For example, if possible paths include 1-2 and 1-2-3, only path 1-2-3 may be included in the paths to evaluate. In this manner, all nodes from all possible paths may be included in the policy-based role inspection, without re-evaluating sub-paths.

At 606, the method may include inspecting permissions of nodes in each path. The permissions of each node may be evaluated to verify whether they align with the intended role permissions of the target role, by performing comparisons between each node's permissions and the target node permissions or policy, at 608.

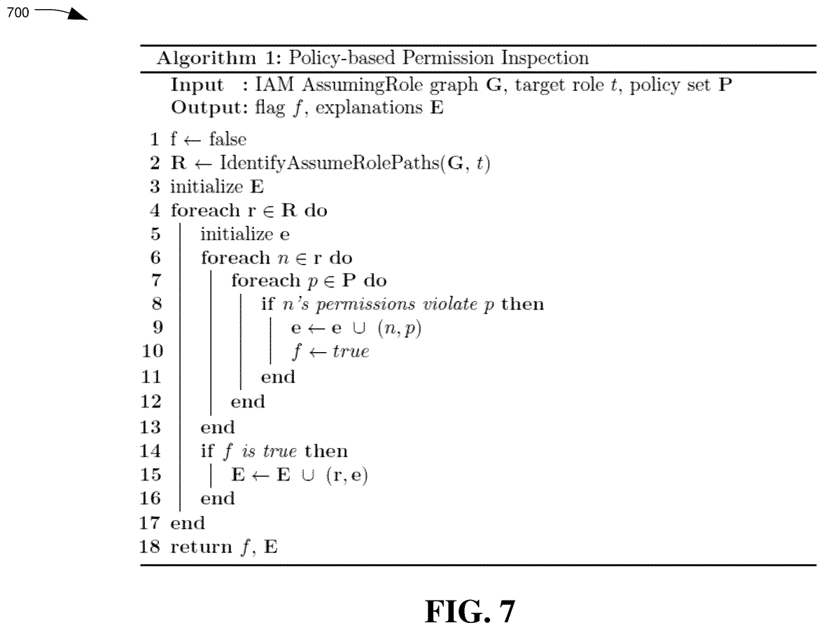

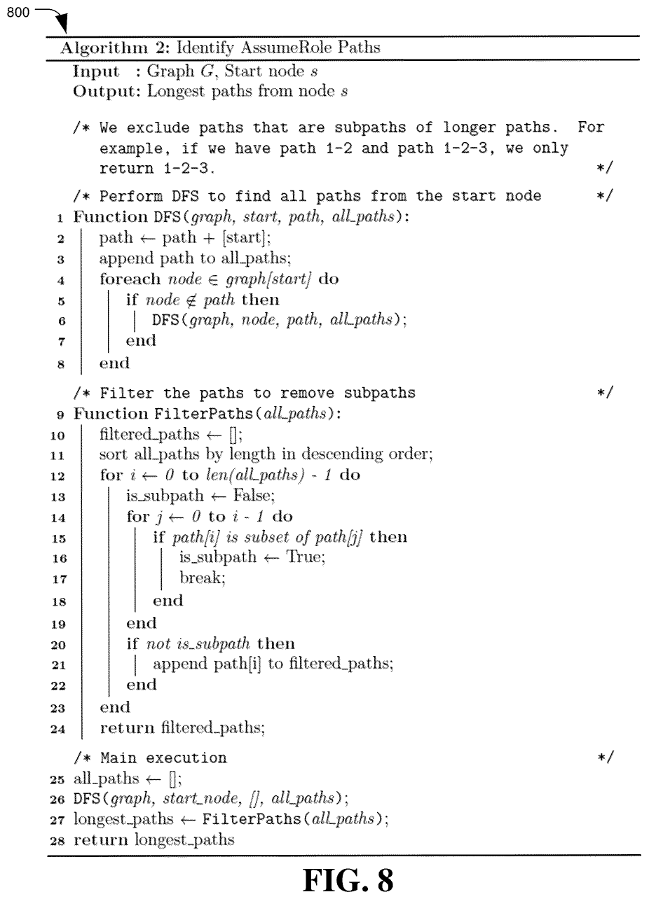

At 610, the method may include identifying any nodes having permissions that exceed the target node's permission or policies. Nodes having permissions exceeding the target node's permissions may be flagged, and the target node may be noted as violating its policies based on the flagged node(s). At 612, the method may include taking correcting action for unintended or violating permissions, such as by adjusting the role endorsement privileges of the target node or another node along the path, of modifying the permissions of the flagged node, or making other configuration adjustments. The corrective action may be taken automatically, or an administrator or security agent for the customer or cloud environment may be notified of the identified policy violation or security risk. Example algorithms for implementing policy-based permission or role inspection and path analysis are shown in FIGS. 7-8.

FIG. 7 depicts an example algorithm 700 for implementing cloud security management, in accordance with certain embodiments of the present disclosure. In particular, algorithm 700 may represent example computer-executable code or pseudocode for performing policy-based permission inspection, as described in regard to FIGS. 5 and 6. The algorithm 700 may be executed by components described in regard to FIG. 1, such as computing platform 102, IAM policy analysis system 110, and database 112 of FIG. 1. Other components, such as cloud customers 104a-n, network 126, and cloud system 106, or some combination thereof, may also be involved in the implementation of the algorithm 700.

The algorithm 700 may provide a process to evaluate a graph “G” to determine whether any of the nodes (e.g., roles or accounts) violates a policy set “P” of a target node “t”. The graph G may include a set of paths “R” from target node t, with each path “r” in the path set R including one or more nodes “n”. If any of the nodes n includes a permission “p” that violates the policy set P, then an error or explanation “e” may be returned. All errors or explanations may be returned in a set “E”.

By implementing the algorithm 700, a system may be able to identify any role that may be endorsed by a target role that violates the target role's policy set, potentially leading to privilege escalation, violating the least privileges principle, or resulting in other security risks.

Turning now to FIG. 8, an example algorithm 800 for implementing cloud security management is shown, in accordance with certain embodiments of the present disclosure. In particular, algorithm 800 may represent example computer-executable code or pseudocode for identifying role endorsement paths (e.g., based on roles that are or can be endorsed from a given role or account using AssumeRole or similar functionality). The algorithm 800 may be executed by components described in regard to FIG. 1, such as computing platform 102, IAM policy analysis system 110, and database 112 of FIG. 1. Other components, such as cloud customers 104a-n, network 126, and cloud system 106, or some combination thereof, may also be involved in the implementation of the algorithm 800.

The algorithm 800 may receive as input a graph “G” and a starting node “s”, and may output the longest role endorsement paths from node s. The algorithm 800 may exclude paths that are subpaths of longer paths. In the example embodiment, algorithm 800 may employ a depth-first search (DFS) to identify the role chain paths.

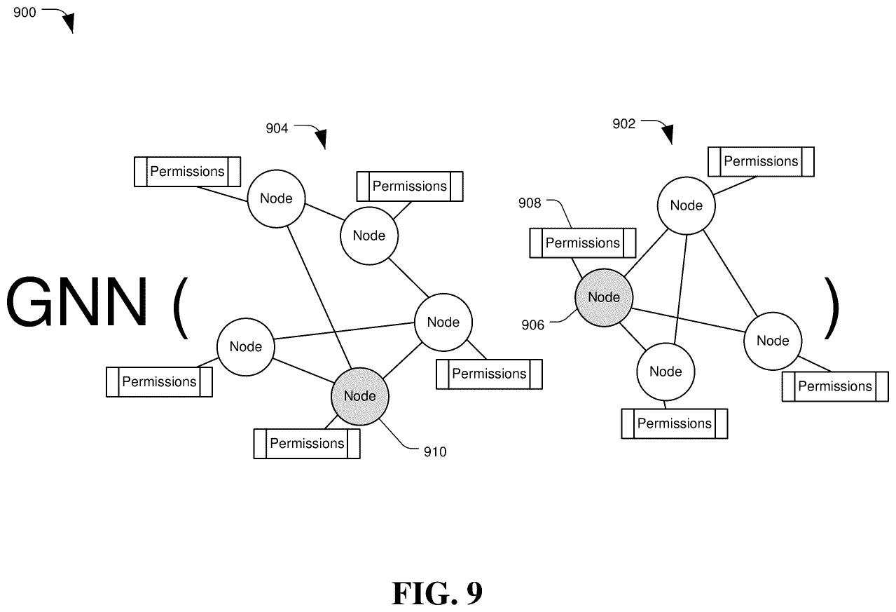

A first function of algorithm 800 may perform the DFS, to identify all potential paths branching off from the start node ‘s’, and adding them to a collection of “all_paths”. A second function of algorithm 800 may filter the collection of “all_paths” to identify any paths that are a subset of another path in “all_paths”. The filtered paths may be collected in a “filtered_paths” data structure, which value may then be used for a “longest_paths” variable. Algorithms 700 and 800 may be used in conjunction to identify all paths from a target role, and then evaluate all roles along those paths to determine whether any of the roles violate the permissions policy for the target role. The application of a graph neural network (GNN) to implement aspects of cloud security management is described in regard to FIG. 9.

FIG. 9 depicts a diagram of a system 900 configured to implement cloud security management, in accordance with certain embodiments of the present disclosure. In particular, system 900 may utilize a GNN to identify and analyze nodes in a graph by following a systematic approach to extract meaningful insights. As noted above, according to some embodiments, an IAM policy analysis system (e.g., IAM policy analysis system 110 or 210) may make use of a GNN (e.g., GNN 212) to facilitate various usage scenarios, including, but not limited to performance of static analysis by a static analysis module (e.g., static analysis module 211), performance of proactive security analysis by a proactive security module (e.g., proactive security module 213), or performance of compromise analysis by a compromise analysis module (e.g., compromise analysis module 215).

A GNN may be a machine learning neural network adapted to leverage the structure and properties of graphs by operating on graph data. A GNN may be used to perform a graph-based role similarity inspection. For example, if a compromised or potentially compromised node is identified in one graph or system, that graph can be provided to the GNN to compare against other graphs, even potentially from other systems. The GNN may use similarity detection to identify nodes in other graphs that are close to the concerning or troublesome node in the latent space. In machine learning and artificial intelligence (AI), a latent space may be a lower-dimensional representation of high-dimensional data that helps make patterns in the data easier to understand. Identified similar nodes may then be inspected to determine whether they also pose a security risk or share policy misconfigurations. Utilizing a GNN to identify similar nodes to a node that has known security vulnerabilities may allow security personnel to quickly identify security vulnerabilities in other roles or within other systems.

In the example system 900, a first graph 902 may be provided to the GNN for comparison. In particular, the first graph may have a plurality of nodes, including a target node 906 that is troublesome or concerning. Each node within the first graph 902 may have a corresponding set of permissions, such as permission set 908 for target node 906. The permissions of the nodes may be used as vector data defining the nodes within the graph 902, and may be used to help identify similarly-situated nodes in other graphs.

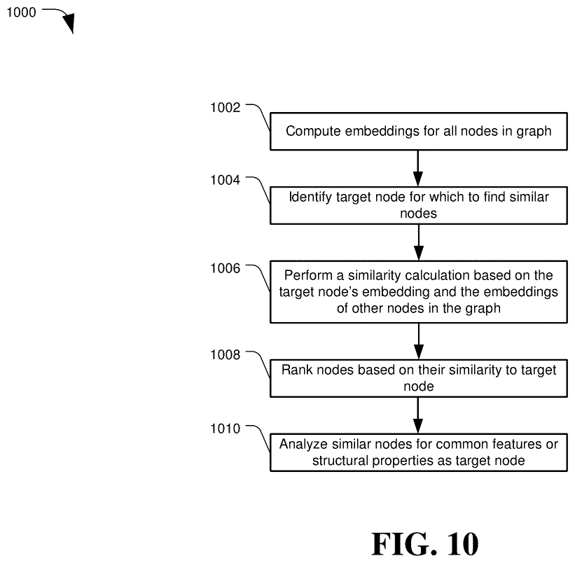

The GNN may compare the first graph 902 to a second graph 904, which may represent potential endorsement or inheritance paths from a particular node within a same system, or a graph from another system (e.g., from another cloud customer's role or account configurations). Based on comparing the first graph 902 and its target node 906 to the second graph 904, the GNN may be able to identify a node 910 in the second graph 904 that is similar to the target node 906 in the latent space. The similar node 910 may then be analyzed to understand common features or structural properties. This can provide insights into why certain nodes are classified similarly, potentially revealing underlying patterns or issues within the graph 904. An example method for implementing the graph-based role similarity inspection is described in regard to FIG. 10.

FIG. 10 depicts a flowchart 1000 of an example method for implementing cloud security management, in accordance with certain embodiments of the present disclosure. In particular, the method of FIG. 10 may be a process for identifying similar roles between graphs by utilizing a GNN. The method may be implemented by components described in regard to FIG. 1, such as computing platform 102, IAM policy analysis system 110, and database 112 of FIG. 1, and by GNN 212 of IAM policy analysis system 210 of FIG. 2. Other components, such as cloud customers 104a-n, network 126, and cloud system 106, or some combination thereof, may also be involved in the method of FIG. 10.

The method may comprise performing embedding extraction, by computing embeddings for all nodes in a graph, at 1002. An unsupervised GNN model may be used to compute the embeddings for all nodes in the graph. Node embeddings may be vector representations that capture the structural and feature information of the nodes. The embedding process may involve passing node features and graph structure through multiple layers of the GNN, which may iteratively aggregate information from neighboring nodes. This process may not require any data labeling efforts from the IAM policy analysis system provider or the cloud customer, so the process can be automated. The computational complexity of this step may be O (|V|+|E|), based on O-notation for the Vertices and Edges.

At 1004, the method may include identifying a target node for which to find similar nodes. For example, consider a node representing a role marked as “concerning.” The target node embedding can be directly extracted from the embeddings computed in the first step 1002. The node identification may be based on user selection, based on the output of an algorithm configured to identify policy-based role or permission configuration issues, or otherwise selected.

The method may include performing a similarity calculation based on the target node's embedding and the embeddings of other nodes in the graph, or in another mapped graph, at 1006. Similarity measures may include cosine similarity, Euclidean distance, or other distance metrics. For cosine similarity, for example, nodes with embeddings closer to 1.0 in cosine similarity may be more similar to the target node.

At 1008, the method may include ranking the nodes in the evaluated graph based on their similarity to the target node. Ranking may include selecting a top-k nodes that have the highest similarity scores, which may indicate that their roles or characteristics are similar to the target node marked as “concerning.”

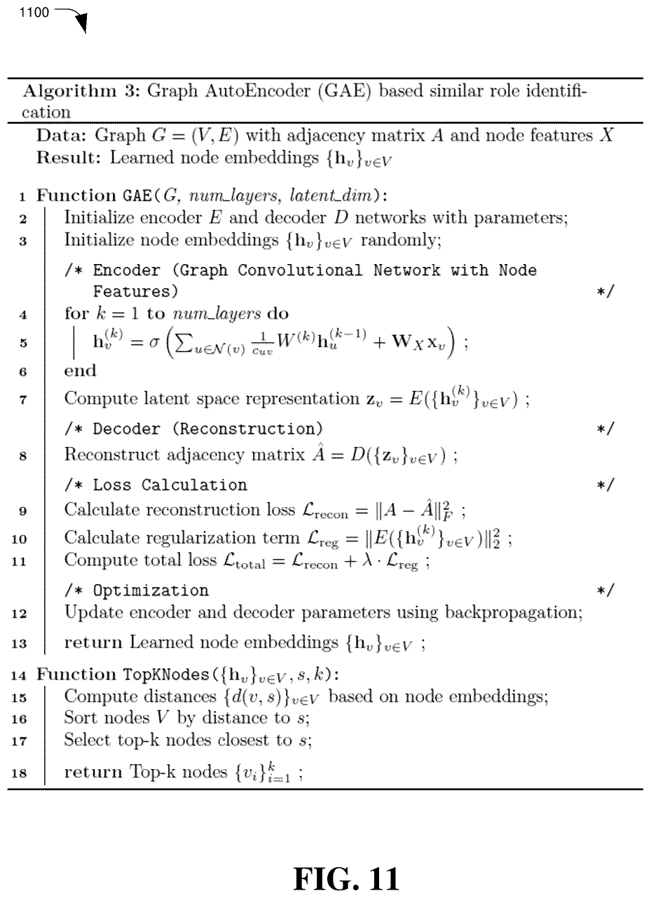

The method may include analyzing the identified similar nodes to understand common features or structural properties, at 1010. This can provide insights into why certain nodes are classified similarly, potentially revealing underlying patterns or issues within the graph. Analysis may be performed automatically via algorithms or training, manually, or via other means. An example algorithm for graph-based role similarity detection using a GNN is described in regard to FIG. 11.

FIG. 11 depicts an example algorithm 1100 for implementing cloud security management, in accordance with certain embodiments of the present disclosure. In particular, algorithm 1100 may represent example computer-executable code or pseudocode for performing graph autoencoder (GAE)-based similar role identification using a GNN. The algorithm 1100 may be executed by components described in regard to FIG. 1, such as computing platform 102, IAM policy analysis system 110, and database 112 of FIG. 1, and by GNN 212 of IAM policy analysis system 210 of FIG. 2. Other components, such as cloud customers 104a-n, network 126, and cloud system 106, or some combination thereof, may also be involved in the implementation of the algorithm 1100.

The algorithm 1100 may have inputs of a graph “G”, comprising a collection of vertices “V” and edges “E”, along with an adjacency matrix “A” and node features “X”. The algorithm may output a collection of learned node embeddings, and calculate a top-k most similar nodes to a selected target node “s”. The algorithm 1100 may first perform a GAE function, which may utilize an encoder to compute a latent space representation of the graph, and a decoder to reconstruct an adjacency matrix. The GAE function may then perform loss calculation and optimization, and return a collection of learned node embeddings. Another function, TopKNodes, may compute the distances of nodes from the target node in latent space, based on the node embeddings, sort them by distance, and return the top k nodes, indicating those nodes most similar to the target node. These top k nodes may be analyzed for their similar features to the target node, helping to identify nodes that may share policy violations or other configuration issues that present security concerns.

The proposed graph-based vulnerable or risky role identification procedures outlined herein may provide numerous benefits or advantages. By creating knowledge graphs of role or node relationships, enumerating AssumeRole paths between nodes, analyzing the outputs of policy-based permission inspection algorithms, and performing similarity analysis between graphs, administrators or security personnel can greatly improve the security landscape of one or more cloud systems. Use of the proposed approach can make it easier for security analysts to prioritize their activities and identify misconfigurations, poor policy definitions, and privilege escalation paths, thereby enabling potential damage resulting from the AssumeRole feature to be proactively addressed. In addition to being fast and efficient, the proposed approach offers more than just the static analysis of trust relationships and privilege escalation paths discovery. For example, the proposed approach may also integrate runtime event data (e.g., CloudTrail) within the knowledge graph, which allows for proactive usage. With this capability, the proposed approach further empowers end-users to detect hazardous roles that can result in unintentional privilege escalations or extensive permission scopes in real-time. Additionally, based on its graph structure, the proposed approach can combine roles across multiple Cloud environments. This feature can provide security analysts and SOC (security operations center) operators with the ability to identify the blast radius across several environments once an over-permissioned or risky role is detected. This feature also enables the concept of least privileges in Cloud Security policies and helps reduce the attack surface.

Modeling IAM using a graph-based approach allows for analysis of IAM policies and providing actionable insights to address these challenges. Mapping trust relationships visualizes the connections between roles and resources, making it easier to identify potential misconfigurations and weaknesses in policy definitions. Identification of privilege escalation paths helps uncover scenarios where users can gain unintended access privileges through a chain of role endorsements. Enabling comprehensive blast radius assessment by analyzing roles across various cloud environments allows security teams to understand potential impact of compromised or misconfigured roles. By identifying excessive permissions and policy weaknesses, the proposed approach enables enforcement of least privilege principles to ensure that users only have the minimum access required for their tasks. By closing potential gaps in access control, the proposed approach can make it more difficult for attackers to exploit vulnerabilities, and therefore reduce the attack surface. The proposed approach allows for the generation of tailored IAM policies by analyzing usage patterns, to create leaner, more specific policies that grant users only the necessary permissions. Additionally, the proposed approach allows for the identification of similar nodes via Graph Neural Network (GNN) driven node clustering by approaching IAM graphs as knowledge graphs, wherein nodes possess attributes and edges convey explicit AssumeRole information. Leveraging GNNs, the system can intelligently group IAM roles. This novel capability empowers the prompt notification of users in the event of one role compromise within a group. An example computing system configured to perform cloud security management as outlined herein is described in regard to FIG. 12.

FIG. 12 is a diagram of an example system 1200 configured to implement zero touch play, in accordance with certain embodiments of the present disclosure. System 1200 may be an example of an apparatus including a computing system 1201 that is representative of any system or collection of systems in which the various processes, systems, programs, services, and scenarios disclosed herein may be implemented. For example, computing system 1201 may be an example of configuration service 102, ZTP device 104, user device 106, content sources 110, display device 112, network 108, or any of the subcomponents depicted in system 100 of FIG. 1. Examples of computing system 1201 include, but are not limited to, server computers, desktop computers, laptop computers, smart devices, routers, switches, web servers, cloud computing platforms, and data center equipment, as well as any other type of physical or virtual server machine, physical or virtual router, cloud containerized application, and any variation or combination thereof.

Computing system 1201 may be implemented as a single apparatus, system, or device or may be implemented in a distributed manner as multiple apparatuses, systems, or devices. Computing system 1201 may include, but is not limited to, processing system 1202, storage system 1203, software 1205, communication interface system 1207, and user interface system 1209. Processing system 1202 may be operatively coupled with storage system 1203, communication interface system 1207, and user interface system 1209.

Processing system 1202 may load and execute software 1205 from storage system 1203. Software 1205 may include cloud security management process 1206, which may be representative of any of the operations for determining and generating knowledge graph representations of trust relationships between roles in a cloud computing system, identifying “AssumeRole” or other role or permission endorsement paths, inspecting role nodes along the paths to perform policy-based permission inspections, identifying policy violations or privilege escalations, performing graph-based role similarity inspections, prioritizing of identified security risks, or other permission- and resource-based evaluations based on graph representations of cloud environments, as discussed with respect to the preceding figures. When executed by processing system 1202, software 1205 may direct processing system 1202 to operate as described herein for at least the various processes, operational scenarios, and sequences discussed in the foregoing implementations. Computing system 1201 may optionally include additional devices, features, or functionality not discussed for purposes of brevity.

In some embodiments, processing system 1202 may comprise a micro-processor and other circuitry that retrieves and executes software 1205 from storage system 1203. Processing system 1202 may be implemented within a single processing device but may also be distributed across multiple processing devices or sub-systems that cooperate in executing program instructions. Examples of processing system 1202 may include general purpose central processing units, graphical processing units, application specific processors, and logic devices, as well as any other type of processing device, combinations, or variations thereof.

Storage system 1203 may comprise any memory device or computer readable storage media readable by processing system 1202 and capable of storing software 1205. Storage system 1203 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1203 may also include computer readable communication media over which at least some of software 1205 may be communicated internally or externally. Storage system 1203 may be implemented as a single storage device but may also be implemented across multiple storage devices or sub-systems co-located or distributed relative to each other. Storage system 1203 may comprise additional elements, such as a controller, capable of communicating with processing system 1202 or possibly other systems.

Software 1205 (including cloud security management process 1206 among other functions) may be implemented in program instructions that may, when executed by processing system 1202, direct processing system 1202 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1205 may include additional processes, programs, or components, such as operating system software, virtualization software, or other application software. Software 1205 may also comprise firmware or some other form of machine-readable processing instructions executable by processing system 1202.

In general, software 1205 may, when loaded into processing system 1202 and executed, transform a suitable apparatus, system, or device (of which computing system 1201 is representative) overall from a general-purpose computing system into a special-purpose computing system as described herein. Indeed, encoding software 1205 on storage system 1203 may transform the physical structure of storage system 1203. The specific transformation of the physical structure may depend on various factors in different implementations of this description. Examples of such factors may include, but are not limited to, the technology used to implement the storage media of storage system 1203 and whether the computer-storage media are characterized as primary or secondary storage, as well as other factors.

For example, if the computer readable storage media are implemented as semiconductor-based memory, software 1205 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1207 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 1201 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
implementing a graph-based role permission inspection system for identity and access management (IAM) roles in a cloud environment, including:
generating a graph representation of trust relationships between roles, where a first role having a first set of privileges can endorse a second role having a second set of privileges;
determining whether the second set of privileges includes a permission not available in the first set of privileges; and
generating an indicator that the first role violates a policy when the second set of privileges includes the permission not available in the first set of privileges.

2. The method of claim 1 further comprising:
a path includes a first endorsement from the first role to the second role, and a second endorsement from the second role to a third role having a third set of privileges;
determining whether the third set of privileges includes a permission not available in the first set of privileges; and
generating the indicator that the first role violates the policy when the third set of privileges includes the permission not available in the first set of privileges.

3. The method of claim 2 further comprising:
identifying one or more paths of endorsement from the first role within the graph representation;
inspecting each role in each path for corresponding privileges; and
comparing each of the corresponding privileges to the first set of privileges to determine whether the first role violates the policy.

4. The method of claim 3 further comprising:
identifying the one or more paths using a depth-first search algorithm on the graph representation.

5. The method of claim 4 further comprising:
filtering the one or more paths to exclude subpaths within the one or more paths.

6. The method of claim 5 further comprising:
performing graph-based role similarity inspection using a graph neural network (GNN), the graph-based role similarity inspection configured to identify roles in the graph representation most similar to a target role.

7. The method of claim 6 further comprising:
performing the graph-based role similarity inspection, further including:
computing embeddings for all roles in the graph representation, embeddings including vector representations of nodes in a graph;
identifying the target role;
performing a similarity calculation based on a first embedding of the target role and embeddings of other roles in the graph representation; and
ranking the other roles based on similarity scores to the target role.

8. A system comprising:
an identity and access management (IAM) policy analysis system configured to implement a graph-based role permission inspection system for IAM roles in a cloud environment, the IAM policy analysis system configured to:
generate a graph representation of trust relationships between roles, where a first role having a first set of privileges can endorse a second role having a second set of privileges;
determine whether the second set of privileges includes a permission not available in the first set of privileges; and
generate an indicator that the first role violates a policy when the second set of privileges includes the permission not available in the first set of privileges.

9. The system of claim 8 comprising the IAM policy analysis system further configured to:
determine a path in the graph representation, the path including a first endorsement from the first role to the second role, and a second endorsement from the second role to a third role having a third set of privileges;
determine whether the third set of privileges includes a permission not available in the first set of privileges; and
generate the indicator that the first role violates the policy when the third set of privileges includes the permission not available in the first set of privileges.

10. The system of claim 8 comprising the IAM policy analysis system further configured to:
identify one or more paths of endorsement from the first role within the graph representation;
inspect each role in each path for corresponding privileges; and
compare each of the corresponding privileges to the first set of privileges to determine whether the first role violates the policy.

11. The system of claim 10 comprising the IAM policy analysis system further configured to:
identify the one or more paths using a depth-first search algorithm on the graph representation.

12. The system of claim 10 comprising the IAM policy analysis system further configured to:
filtering the one or more paths to exclude subpaths within the one or more paths.

13. The system of claim 8 comprising the IAM policy analysis system further configured to:
perform graph-based role similarity inspection using a graph neural network (GNN), the graph-based role similarity inspection configured to identify roles in the graph representation most similar to a target role.

14. The system of claim 13 comprising the IAM policy analysis system further configured to:
perform the graph-based role similarity inspection, further including:
compute embeddings for all roles in the graph representation, embeddings including vector representations of nodes in a graph;
identify the target role;
perform a similarity calculation based on a first embedding of the target role and embeddings of other roles in the graph representation; and
rank the other roles based on similarity scores to the target role.

15. A memory device storing instructions that, when executed, cause a processor to perform a method comprising:
implementing a graph-based role permission inspection system for identity and access management (IAM) roles in a cloud environment, including:
generating a graph representation of trust relationships between roles, where a first role having a first set of privileges can endorse a second role having a second set of privileges;
determining whether the second set of privileges includes a permission not available in the first set of privileges; and
generating an indicator that the first role violates a policy when the second set of privileges includes the permission not available in the first set of privileges.

16. The memory device of claim 15 storing instructions that, when executed, cause the processor to perform the method further comprising:
determining a path in the graph representation, the path including a first endorsement from the first role to the second role, and a second endorsement from the second role to a third role having a third set of privileges;
determining whether the third set of privileges includes a permission not available in the first set of privileges; and
generating the indicator that the first role violates the policy when the third set of privileges includes the permission not available in the first set of privileges.

17. The memory device of claim 15 storing instructions that, when executed, cause the processor to perform the method further comprising:
identifying one or more paths of endorsement from the first role within the graph representation;
inspecting each role in each path for corresponding privileges; and
comparing each of the corresponding privileges to the first set of privileges to determine whether the first role violates the policy.

18. The memory device of claim 17 storing instructions that, when executed, cause the processor to perform the method further comprising:
identifying the one or more paths using a depth-first search algorithm on the graph representation.

19. The memory device of claim 18 storing instructions that, when executed, cause the processor to perform the method further comprising:
filtering the one or more paths to exclude subpaths within the one or more paths.

20. The memory device of claim 15 storing instructions that, when executed, cause the processor to perform the method further comprising:
performing graph-based role similarity inspection using a graph neural network (GNN), the graph-based role similarity inspection configured to identify roles in the graph representation most similar to a target role, including:
computing embeddings for all roles in the graph representation, embeddings including vector representations of nodes in a graph;
identifying the target role;
performing a similarity calculation based on a first embedding of the target role and embeddings of other roles in the graph representation; and
ranking the other roles based on similarity scores to the target role.
